(19) United States
(12) Patent Application Publication
(10) Pub. No.: US 2015/0265977 A1
(43) Pub. Date: Sep. 24, 2015

(54) FOULING RESISTANT MEMBRANES FOR WATER TREATMENT

(71) Applicant: GENERAL ELECTRIC COMPANY, Schenectady, NY (US)

(72) Inventors: Louisa Ruth Carr, Schenectady, NY (US); Hongchen Dong, Niskayuna, NY (US); Paul Michael Smigelski, JR., Glenville, NY (US); Jason Louis Davis, Albany, NY (US); Jason Michael Nichols, Schenectady, NY (US)

(73) Assignee: GENERAL ELECTRIC COMPANY, Schenectady, NY (US)

(21) Appl. No.: 14/221,892

(22) Filed: Mar. 21, 2014

(51) Int. Cl. B01D 71/70; B01D 69/12; C02F 1/44

(52) U.S. Cl. CPC B01D 71/70; C02F 1/444; B01D 69/12

(57) ABSTRACT

Methods for treating water containing dissolved solids, suspended solids, organic material, or combinations include contacting the water with a coated membrane comprising a coating material disposed on a membrane substrate, the coating material comprising structural units derived from a compound of formula I, a compound of formula II and a compound of formula III;

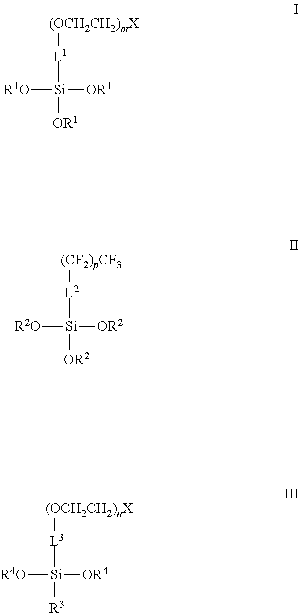

wherein
R¹, R², and R³ are, independently at each occurrence, C₁-C₁₂ alkyl;
R⁴ is alkylsilyl;
L¹ is alkylurethanyl;
L² and L³ are, independently at each occurrence, alkyl;
X is hydroxy, alkoxy, or alkylamino; and
m, n, and p, independently at each occurrence, range between 4 and 9.

The coated membrane is joined to a backing in membrane filtration apparatuses for use in the methods.

### BACKGROUND

The volume of fresh water required for the production and processing of earth-bound natural resources, such as oil, gas, and mining extracts, is enormous and second only to the volume used for agriculture. Almost all the resulting water produced from underground natural resources requires some form of treatment before it can be reused or disposed, and even more significant purification efforts before it can be discharged. Currently, an estimated 70 billion barrels of produced water is generated each year worldwide. Produced water volumes from oil and gas extraction are projected to increase significantly as aging wells produce more water per barrel of oil. Concurrently, unconventional energy production from hydraulic fracturing and oil sands is experiencing strong growth that is expected to continue. Increasing awareness of water scarcity issues and tightening government regulation of water use permitting and discharge requirements are driving efforts to improve produced water treatment options to minimize disposal by increasing water reuse and beneficial discharge.

Produced water contains high levels of total suspended solids (TSS), including dirt, sand, clay, bacteria, insoluble salts, total dissolved solids (TDS), generally salts, and total organic carbon (TOC), including dissolved and emulsified oils, grease, and chemical additives from drilling operations. The relative quantities of TSS, TDS, and TOC vary greatly depending on the water source, upstream use, and natural production cycles. Any level of water treatment must therefore contend with all three classes of contaminates and their variance making no single unit operation capable of being a total solution. A process train of separate unit operations must therefore be designed to treat produced water with the degree of treatment dependent upon 1) the influent water quality (TSS, TDS, and TOC levels), and 2) the requirements of effluent water quality. Effluent water quality is dictated in turn by the downstream fate of the water: water for reuse in hydrofracturing may only require TSS removal, whereas processing produced water to clean brine necessitates removal of both TSS and TOC. Water that is destined for municipal reuse or discharge must be treated for all three classes of contaminates.

TSS removal is generally the first, or one of the first, operations to be performed in the treatment process. It is therefore necessary that TSS removal operations be robust in the presence of TDS and TOC. While TDS are generally benign, dissolved and emulsified oils/carbon found in produced water (TOC) can cause significant fouling problems. Therefore, there is a need for permanent hydrophilic and oleophobic (oil-tolerant) membranes, to enable them to filter high-TSS, -TDS, and -TOC water without being fouled by free and dissolved oil, and therefore economically remove TSS from produced water.

### BRIEF DESCRIPTION

Briefly, in one aspect, the present invention relates to a method for treating water containing dissolved solids, suspended solids, organic material, or a combination thereof, the method comprising contacting the water with a coated membrane comprising a coating material disposed on a membrane substrate, the coating material comprising structural units derived from a compound of formula I, a compound of formula II and a compound of formula III;

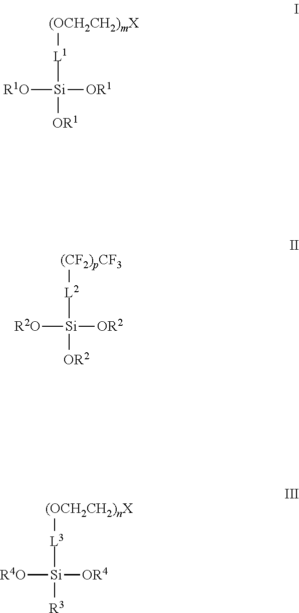

wherein
R¹, R², and R³ are, independently at each occurrence, C₁-C₁₂ alkyl;
R⁴ is alkylsilyl;
L¹ is alkylurethanyl;
L² and L³ are, independently at each occurrence, alkyl;
X is hydroxy, alkoxy, or alkylamino; and
m, n, and p, independently at each occurrence, range between 4 and 9.

In another aspect, the present invention relates to a membrane filtration apparatus comprising a coated membrane joined to a backing, the coated membrane comprising a coating material disposed on a membrane substrate, the coating material comprising structural units derived from a compound of formula I, a compound of formula II and a compound of formula III.

### DETAILED DESCRIPTION

In particular embodiments, the coating material disposed on a membrane substrate includes structural units derived from the compounds below

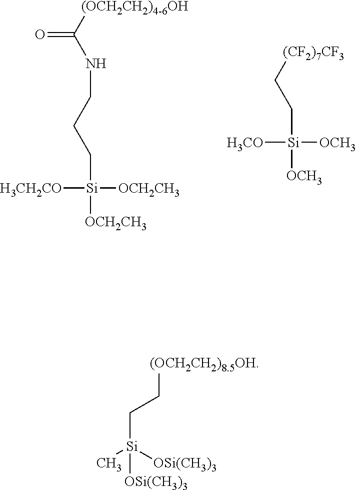

In various embodiments, about 50-80% of the structural units of the coating material may be derived from a compound of formula I, about 10-30% of the structural units may be derived from a compound of formula II, and about 5-15% of the structural units may be derived from a compound of formula III.

In another aspect, present invention relates to a method for treating water containing dissolved solids, suspended solids, organic material, or a combination thereof, the method comprising contacting the water with a coated membrane comprising a coating material disposed on a membrane substrate, the coating material comprising structural units derived from a compound of formula IV, a compound of formula V and a compound of formula VI

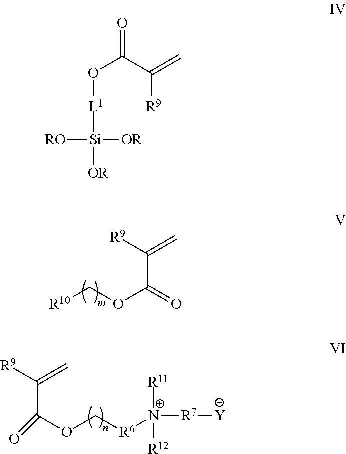

wherein
R⁹ is independently at each occurrence a hydrogen, or a linear or branched C₁-C₄ alkyl group;
R¹⁰ is a linear or branched C₁-C₃₀ fluoroalkyl group;
R¹¹ and R¹² are independently at each occurrence a linear or branched C₁-C₁₂ alkyl group; a C₅-C₁₂ carbocyclic group, or a C₅-C₁₂ heterocyclic group, and R⁶ and R⁷ are independently at each occurrence a linear or branched C₁-C₁₂ alkylene group, a linear or branched C₂-C₁₂ alkenylene group, a linear or branched C₂-C₁₂ alkylnlene group, a C₅-C₁₂ carbocyclic group, or a C₅-C₁₂ heterocyclic group, or at least two of R¹¹, R¹², R⁶, and R⁷ together with the nitrogen atom to which they are attached form a heterocyclic ring containing 5 to 7 atoms;
Y is an anionic group; and
m and n are independently at each occurrence an integer ranging from 1 to 5.

A membrane substrate for use with the coating material in the methods and membrane filtration apparatus of the present invention may be composed of a polymeric material, including, but not limited to, polytetrafluoroethylene (PTFE), expanded polytetrafluoroethylene (ePTFE), polyolefin, polyester, polyamide, polyether, polysulfone, polyethersulfone, polyvinylidine fluoride, polystyrene, polyethylene, polypropylene, (meth)acrylate, polyurethane, cellulose-based materials and combinations thereof. In particular, the membrane substrate may composed of ePTFE, more particularly, ePTFE membrane backed with PTFE.

The membrane substrate may have a pore size ranging from about 0.01 micron to about 50 micron. In some example embodiments, the membrane substrate may have pore sizes ranging from about 0.01 microns to about 50 microns. In some other embodiments, the pore sizes of the membrane substrate may range from about 0.1 micron to about 10 microns. In some other example embodiments, the pore sizes of the membrane substrate may range from about 0.3 micron to about 2 microns.

The coating material may be applied to a membrane substrate by any suitable method, for example, by roll-coating, dip-coating (immersion), or spray-coating. The copolymer composition may be coated on to the membrane substrate by dissolving it in an appropriate solvent. For example, the copolymer may be dissolved in tetrafluoro propanol or hexafluro isopropanol and this copolymeric solution may be employed for coating the membrane substrate. Coating composition may further include stabilizing agents and/or activators. The coating composition, in a suitable solvent, may be applied to the membrane substrate such that the coating composition passes through the pores and wet-out surfaces of the membrane substrate. At least a portion of the membrane substrate including surfaces of pores may be coated with the coating composition without blocking the pores. The coating composition may be then cured by heating the membrane substrate such that the copolymer flow and coalesce to form coating onto the membrane substrate followed by solvent evaporation. In one embodiment, immersion procedure is used to coat the filtration membrane with the coating composition. The copolymer coating composition may be applied on the membrane substrate at low percent loading, for example, about 0.1 to about 1 wt %, to minimize pore constriction. This may vary depending on the weight of the membrane substrate as well. In some embodiments, the coating composition include about 0.2 wt % of the copolymer.

In some embodiments, the membrane filtration apparatus may additionally include a backing material. The membrane substrate and the backing materials may be integrally joined by techniques well known in the art. Non-limiting examples of backing material include woven or nonwoven synthetic materials having the strength necessary to reinforce the filtration membrane and the ability to be integrally bound to the membrane while not interfering with the passage of permeate through the membrane. Suitable backing materials may include polytetrafluoroethylene, polyester, polypropylene, polyethylene and nylon. In one example embodiment, the backing is polytetrafluoroethylene.

The coated membrane may be a microfiltration membrane or an ultrafiltration membrane. The coating may render a microfiltration membrane oil-tolerant. By incorporating hydrophilicity and oleophobicity to a microfiltration membrane, the copolymer coatings enable filtration of oil-produced water such as is found in unconventional gas and oil production. Copolymer-coated microfilters may be employed to reject oily suspended solids such as dirt and other small particles. In the absence of such coatings, oil in the produced water (e.g., as emulsified oil) typically fouls the membrane and precludes economic operation. Oil-tolerant microfilters pass oil-droplets and dissolved oil without being fouled by them. The copolymeric coating may also render an ultrafiltration membrane oil-tolerant and oil-rejecting. Coated ultrafiltration membranes, being oleophobic, may reject oil droplets to avoid being fouled by the oil.

Water for treatment by a method according to the present invention may be produced water from oil-sands, coalbed methane, unconventional gas, enhanced oil-recovery, salt-water aquifers, or mining processes. The water may have oil in a dispersed phase and water is a continuous phase. For example, the water may be the produced water from the petroleum industries, the produced water in the production of conventional or unconventional natural gas, or shale gas-produced water. The water may often contain a mixture of water and hydrocarbon (e.g., oil) and may further comprise oily suspended particles and high levels of dissolved solids (e.g., dissolved salts). For example, the water may contain organic components in a range between 1 and 1000 ppm. Further, for example, it may contain free un-dissolved oil in a range between 1 and 500 ppm, dissolved solids in a range between 500 and 200000 ppm, and suspended particles in a range between 1 and 2000 ppm.

In yet another aspect, the present invention relates to a method from treating water, wherein the water is combined or pretreated with a water dispersable polymer before contacting the coated membrane with the water. The water dispersable polymer is selected from coagulants, anionic flocculants, cationic flocculants, nonionic flocculants, and combinations thereof.

Polymeric coagulants are typically cationic materials with relatively low molecular weights (under 500,000). Cationic polyelectrolytes commonly used as coagulants include polyamines or polyquaternary polymers such as those described in US reissued patents RE28,807 and RE28,807, formed from reaction of a secondary amine such as dimethylamine and a difunctional epoxide such as epichlorohydrin, and poly-(DADMACS). Cationic acrylamide copolymers may include cationic repeat units based on allyltrialkylammonium monomers such as polydiallyldimethyl ammonium chloride (DADMAC), allyl triethyl ammonium chloride, or ammonium alkyl(meth)acrylates. The mole percent of the cationic repeat units in the cationic coagulant copolymer is typically at least 50%, and other monomers, if present, are neutral monomers, e.g., acrylamide. The molecular weight of the polycationic coagulants is preferably at least 5000 and may also range from about 100,000 or more up to about 1,000,000.

Polymeric flocculants may be anionic, cationic, nonionic, or an appropriate combination thereof, such as anionic and nonionic or cationic and nonionic. Molecular weight of the flocculants is particularly about 1 to 30 million, more particularly 12 to 25 million, and most particularly 15 to 22 million Daltons. Anionic flocculants include anionic acrylamide copolymers, specifically copolymers of acrylamide and acrylic acid. Cationic flocculants include cationic acrylamide copolymers that include cationic repeat units based on allyl trialkyl ammonium chloride. A representative cationic acrylamide copolymer is a copolymer of acrylamide and allyl triethyl ammonium chloride (ATAC). Other cationic repeat units that may be present in the acrylamide copolymer include those derivable from ammonium alkyl(meth)acrylamides, ammonium alkyl(meth)acrylates, allyl trialkyl ammonium salts and diallyl dialkylammonium salts. The acrylamide flocculant copolymers generally have about 50-95 mole percent, preferably 70-90 mole percent and more preferably about 80-90 mole percent acrylamide residue. Nonionic flocculants include polymers such as polyacrylamide, polyvinyl alcohol, polyethylene glycol, polypyrrolidone, polyethylene amine, and polysaccharides, such as cellulose, including activated starch as described in WO 2007/047481.

In addition to coagulants or flocculants, water to be treated by a membrane filtration apparatus according to the present invention may include other materials that are known to foul prior art membranes, including natural organic matter (NOM), such as humic acid, algal organic matter, and cell fragments, biomolecules, such as proteins and bacteria, and all types of surfactants.

### DEFINITIONS

In the context of the present invention, alkyl is intended to include linear, branched, or cyclic hydrocarbon structures and combinations thereof, including lower alkyl and higher alkyl. Preferred alkyl groups are those of C₂₀ or below. Lower alkyl refers to alkyl groups of from 1 to 6 carbon atoms, preferably from 1 to 4 carbon atoms, and includes methyl, ethyl, n-propyl, isopropyl, and n-, s- and t-butyl. Higher alkyl refers to alkyl groups having seven or more carbon atoms, preferably 7-20 carbon atoms, and includes n-, s- and t-heptyl, octyl, and dodecyl. Cycloalkyl is a subset of alkyl and includes cyclic hydrocarbon groups of from 3 to 8 carbon atoms. Examples of cycloalkyl groups include cyclopropyl, cyclobutyl, cyclopentyl, cyclohexyl, and norbornyl. Alkenyl and alkynyl refer to alkyl groups wherein two or more hydrogen atoms are replaced by a double or triple bond, respectively.

Aryl and heteroaryl mean a 5- or 6-membered aromatic or heteroaromatic ring containing 0-3 heteroatoms selected from nitrogen, oxygen or sulfur; a bicyclic 9- or 10-membered aromatic or heteroaromatic ring system containing 0-3 heteroatoms selected from nitrogen, oxygen or sulfur; or a tricyclic 13- or 14-membered aromatic or heteroaromatic ring system containing 0-3 heteroatoms selected from nitrogen, oxygen or sulfur. The aromatic 6- to 14-membered carbocyclic rings include, for example, benzene, naphthalene, indane, tetralin, and fluorene; and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl and phenethyl. Heteroarylalkyl means an alkyl residue attached to a heteroaryl ring. Examples include pyridinylmethyl and pyrimidinylethyl. Alkylaryl means an aryl residue having one or more alkyl groups attached thereto. Examples are tolyl and mesityl.

Alkoxy or alkoxyl refers to groups of from 1 to 8 carbon atoms of a straight, branched, cyclic configuration and combinations thereof attached to the parent structure through an oxygen. Examples include methoxy, ethoxy, propoxy, isopropoxy, cyclopropyloxy, and cyclohexyloxy. Lower alkoxy refers to groups containing one to four carbons.

Acyl refers to groups of from 1 to 8 carbon atoms of a straight, branched, cyclic configuration, saturated, unsaturated and aromatic and combinations thereof, attached to the parent structure through a carbonyl functionality. One or more carbons in the acyl residue may be replaced by nitrogen, oxygen or sulfur as long as the point of attachment to the parent remains at the carbonyl. Examples include acetyl, benzoyl, propionyl, isobutyryl, t-butoxycarbonyl, and benzyloxycarbonyl. Lower-acyl refers to groups containing one to four carbons.

Heterocycle means a cycloalkyl or aryl residue in which one or two of the carbon atoms is replaced by a heteroatom such as oxygen, nitrogen or sulfur. Examples of heterocycles that fall within the scope of the invention include pyrrolidine, pyrazole, pyrrole, indole, quinoline, isoquinoline, tetrahydroisoquinoline, benzofuran, benzodioxan, benzodioxole (commonly referred to as methylenedioxyphenyl, when occurring as a substituent), tetrazole, morpholine, thiazole, pyridine, pyridazine, pyrimidine, thiophene, furan, oxazole, oxazoline, isoxazole, dioxane, and tetrahydrofuran.

Substituted refers to residues, including, but not limited to, alkyl, alkylaryl, aryl, arylalkyl, and heteroaryl, wherein up to three H atoms of the residue are replaced with lower alkyl, substituted alkyl, alkenyl, substituted alkenyl, aryl, substituted aryl, haloalkyl, alkoxy, carbonyl, carboxy, carboxalkoxy, carboxamido, acyloxy, amidino, nitro, halo, hydroxy, OCH(COOH)₂, cyano, primary amino, secondary amino, acylamino, alkylthio, sulfoxide, sulfone, phenyl, benzyl, phenoxy, benzyloxy, heteroaryl, or heteroaryloxy.

Haloalkyl refers to an alkyl residue, wherein one or more H atoms are replaced by halogen atoms; the term haloalkyl includes perhaloalkyl. Examples of haloalkyl groups that fall within the scope of the invention include CH₂F, CHF₂, and CF₃.

Oxaalkyl refers to an alkyl residue in which one or more carbons have been replaced by oxygen. It is attached to the parent structure through an alkyl residue. Examples include methoxypropoxy, 3,6,9-trioxadecyl and the like. The term oxaalkyl refers to compounds in which the oxygen is bonded via a single bond to its adjacent atoms, forming ether bonds; it does not refer to doubly bonded oxygen, as in carbonyl groups. Similarly, thiaalkyl and azaalkyl refer to alkyl residues in which one or more carbons has been replaced by sulfur or nitrogen, respectively. Examples include ethylaminoethyl and methylthiopropyl.

Silyl means an alkyl residue in which one to three of the carbons is replaced by tetravalent silicon and which is attached to the parent structure through a silicon atom. Siloxy is an alkoxy residue in which both of the carbons are replaced by tetravalent silicon that is endcapped with an alkyl residue, aryl residue or a cycloalkyl residue, and which is attached to the parent structure through an oxygen atom.

### EXAMPLES

### General Procedures

### Method of Preparing Coated Membranes

Solutions of silane monomer and crosslinkers were prepared in 2-propanol to a concentration which allowed the desired amount of coating material (typically calculated from the difference between the coated membrane weight and the uncoated membrane weight as “weight-percent add-on”. Weight-percent add-on=100*(coated membrane weight−uncoated membrane weight)/uncoated membrane weight).

Sufficient material to impart the desired physical properties (hydrophilicity and oleophobicity) to the membrane while retaining high levels of permeability was provided at about 5 wt % add-on, from a 0.16 wt % coating solution which included 0.2% activator solution. The activator solution was composed of 0.93% potassium hydroxide in 3:1 water:2-propanol. Solutions are chilled prior to addition of the activator solution, to reduce reactivity until the cure step. The membrane was then spray coated or dip coated.

Spray-coating: Unbacked membranes were secured to supports to ensure uniform tension and prevent shrinkage or other distortion upon wet-out with the coating solution. Coating solution was sprayed onto the membrane to create a uniform wetting that was sufficient to saturate the membrane but not occlude the pores upon cure. For bench-scale coating, a Central Pneumatic Professional HVLP 20 oz gravity spray gun with 8 psi pressure through a 1.4 mm nozzle was used, and three passes of the spray were required to gain full coverage without overcoating. The membranes, still in the support, were then heat-cured at 90° C. in a vented oven for a minimum of 4-6 hours to ensure complete polymerization. Prior to use in filtration, the unbacked membrane were physically laminated to PTFE felt using a bench-top nip-roller (Marcato Atlas 150 pasta maker with adjustable gap settings. Settings 5-6 were used) to apply pressure and reversibly laminate the two layers together.

Dip-Coating:

Backed membranes, ˜2.5×5-inch rectangles, were submerged in coating solution and thoroughly soaked to remove all pockets of air within the backing. They were then removed from the coating solution bath, and excess coating solution was stripped off using a bench-top nip-roller (Marcato Atlas 150 pasta maker with adjustable gap settings. Settings 5-7 were used.). Membrane swatches were then stood on end in a heat-resistant rack to maximize heat transfer and cured at 90° C. in a vented oven overnight to ensure complete polymerization. For future scale-up efforts, a preliminary feasibility study of dip-coating unbacked membrane was successfully performed, in which unbacked membranes were secured to a nonporous backing. For bench-scale coating, ˜12×12-inch squares of Teflon sheet were used as backing, and membrane was fastened along the edges with ½-inch pieces of double-sided tape spaced about ½-inches apart. These “backed” membranes were then submerged in the coating solution and run membrane-side-down through a pneumatically actuated set of nip-rollers at a pressure of 10 PSI and a rate of 3 ft/min. Nip roll materials are: Upper=ethylene propylene diene monomer rubber-coated steel, and lower=stainless steel. The membranes, still on the nonporous backing, were then heat-cured for a minimum of 4-6 hours to ensure complete polymerization. After cure, these membranes were carefully removed from the Teflon sheet and laminated to Teflon felt as described above.

### Examples 1-15

### Wash-Off

To gage permanence of the coating, the amount of cured coating material on the backed membrane was then measured after a 1-hour soak in water followed by a 1-hour soak in 2-propanol. A permanent coating would retain the initial amount of coating material through these washing steps, whereas an incomplete cure would result in unreacted monomers/crosslinkers or small oligomers that wash off of the backed membrane.

TABLE 1

| | | | Trade name | |
|---|---|---|---|---|
| Ex. # | Formulation | % retain'd | (Gelest) | Chemical structure |
| 1 | 100% SIB1824.84 | ~100% | SIB1824.84 | 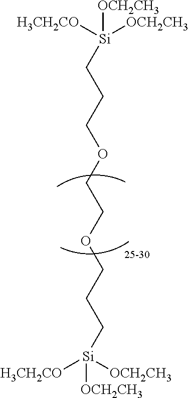 |
| 2 | 75% SIT8192.0 25% SIB1824.84 | ~100% | SIT8192.0 | 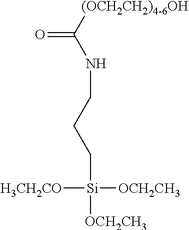 |
| 3 | 67% SIM6555.0 33% SIH6185.0 | 78% | SIM6555.0 | 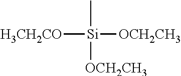 |
| 4 | | | SIH6185.0 | 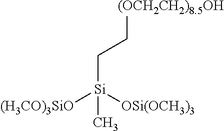 |
| 5 | 100% SIA0200.0 | ~100% | SIA0200.0 | 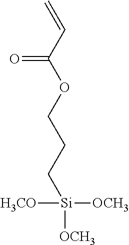 |
| 6 | 4% SIN6597.65 20% SIH6185.0 76% SIT8192.0 | 96% | SIN6597.65 (n = 3) | 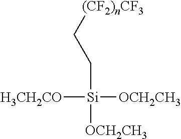 |
| 7 | 4% SIT8175.0 20% SIH6185.0 76% SIT8192.0 | 95% | SIT8175.0 (n = 5) | |
| 8 | 4% SIP6720.5 20% SIH6185.0 76% SIT8192.0 | 100% | SIP6720.5 (n = 9-11) | |
| 9 | 4% SIH5814.5 20% SIH6185.0 76% SIT8192.0 | 95% | SIH5841.5 (n = 7) | 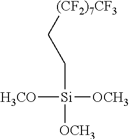 |
| 10 | 100% SIM6592.0 | 18% | SIM6592.0 | 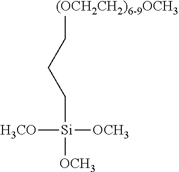 |
| 11 | 84% SID3547.0 16% SID3546.94 | 7% | SID3547.0 | 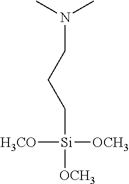 |
| 12 | 63% SIT6415.0 31% SIH6185.0 6% SIH5841.5 | 10% | SIT8415.0 | 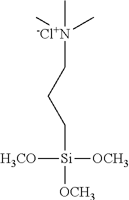 |
| 13 | 98% SIH6185.0 2% SIH5841.5 | 4% | | |
| 14 | 53% SIH6185.0 47% SIM6492.7 | 15% | SIM6492.7 | 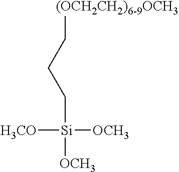 |
| 15 | 21% SIH6185.0 4% SIH 5841.5 75% SIT8192.0 | 94% | SIT8192.0 | 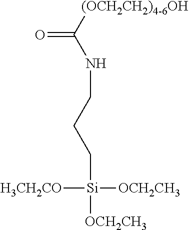 |

### Filtration

4.5-cm diameter disks were punched from the backed membranes (either uncoated and commercially backed or coated and reversibly laminated to the backing) and loaded into a 50-ml Millipore Amicon Bioseparations ultrafiltration cell. The laminated membranes required extreme care during seating and when sealing with the rubber o-ring to avoid peeling the membrane from the backing. Laminated membranes were wetted with IPA, which seemed to lessen this risk. Uncoated membranes were wet with IPA to enable flow of water through the pores; the coated membranes remained wet from the IPA added to facilitate handling. The Amicon cell's feed line was split by a valve between two separate pressurized stir-tanks, one of DI water and one for the test water, for rapid and simple switching between DI water and test water feeds. These two tanks were pressurized together. A by-pass line of pressurized nitrogen was also plumbed in to aid in emptying the cell by forcing feed water through the membrane. The exit line of the Amicon cell was fed to a capture vessel on a balance so that flux could be measured gravimetrically as a function of time, and these data were collected using Mettler Toledo BalanceLink software on a lap-top computer connected to the balance via an RS232 cable.

Immediately prior to a run, the two pressurized feed vessels were pressurized to 6 psig, the balance tared, and data collection begun. The DI water feed line was opened and DI water was allowed to fill the Amicon cell. When the cell was filled, the vent port on top the cell was closed, directing flow through the membrane. When 500 grams of DI water had flowed through the membrane and a stable flux had been achieved, the DI feed line was closed and the nitrogen line was opened, to empty all by ˜10 ml of the remaining DI water from the cell via transport through the membrane. The last bit of water was left in the cell to prevent de-wetting of the membrane. The nitrogen line was then sealed and the cell vented to atmospheric pressure. The collection vessel on the balance was emptied. The feed line was then switched to the test water (synthetic or field-produced water). As with the DI water, the test water was allowed to fill the Amicon cell before the vent was closed to initiate flux through the membrane. Filtrate was clear; suspended solids were unable to pass the barrier layer and built up a cake layer on the membrane. After 400 grams of test water filtrate had been collected, the feed line was switched to nitrogen long enough to create some head-space in the amicon cell. The cell was vented, remaining test water poured out of the cell, and the cake layer on the membrane was washed off with a gentle stream of DI water from a squeeze bottle until the cake was removed or until the DI stream became ineffective and no more of the cake was being removed. The feed line was flushed with DI water to remove test water from the line downstream of the valve. The cell was closed, the collection vessel emptied once more, and a second identical 500-gram DI water flow was initiated. The “flux recovery” for one cycle was defined as 100*2^{nd} DI water flux rate/1^{st} DI water flux rate.

Three-cycle tests were run, which included two additional filtrations of 400 grams of test water separated by cake removal and 500 grams of DI water filtration. The flux recovery for multi-cycle tests was defined as 100*Final DI water flux rate/1^{st} DI water flux rate.

### Example 16

A membrane spray-coated with a coating material having the composition shown in Table 2 (˜19% 3-[hydroxy(polyethyleneoxy)-propyl]heptamethyltrisiloxane, ˜10% (heptadecafluoro-1,1,2,2-tetrahydrodecyl)trimethoxysilane, and ˜71% n-(tri-ethoxysilylpropyl)-o-polyethylene oxide urethane) was used to filter dirty and oily water (1000 ppm total suspended solids; 102,500 ppm total dissolved solids; and 250 ppm total organic carbon) for three cycles of filtration. A cycle consists of filtration of 400 grams of the dirty and oily water, a clean water rinse of the membrane, and a DI water flux measurement. An initial DI water flux measurement was obtained, and “recovery” is defined as the DI water flux after the final cycle compared to the initial DI water flux. The filtration profile for 3 cycles of dirty-oily water using the most preferred coated membrane demonstrated 94% recovery, whereas an uncoated membrane demonstrated 62% recovery. A further improvement in the consistency of the average flux per cycle of the 400 g dirty and oily water per cycle was observed with the coated membrane:

TABLE 2

| Component | Amount | |
|---|---|---|
| Gelest SIH6185.0 | 0.064 g (19 wt %) | 0.16% |
| Gelest SIT8192.0 | 0.243 g(71 wt %) | |
| Gelest SIH5841.5 | 0.034 g (10 wt %) | |
| KOH/H₂O/IPA | 0.456 g | 0.20% |
| IPA | 199 g | 99.64% |

### Examples 17-20

Unbacked membranes were spray-coated with a solution of alkoxysilane SIA0200.0 and a mixture composed of 90 wt % SIA0200.0 and 10 wt % SIH5841.5 (total silane concentration 0.25 wt % based on the total weight of the solution) and cured temperature at 60° C. After cure, membranes were reversibly laminated to PTFE felt backing. For Examples 19 and 20, the laminated membranes of Example 17 were then submerged in a solution of the SBMA methacrylate monomer or a 1:1 mixture (wt/wt) of SBMA and FMA monomers and VAZO-52 initiator in an IPA/water mixture. The solution was heated to 65° C. for 2 hours to initiate polymerization. After polymerization, the membrane laminates were washed with water for one-hour, then with IPA for one hour to remove unreacted monomers and free-solution oligomers. Results are shown in Table 3.

TABLE 3

| | | Recovery, | | |
|---|---|---|---|---|
| Ex. # | Formulation | % | Trade name | Chemical structure |
| 17 | 100% SIA0200.0 | 89 | SIA0200.0 (Gelest) | 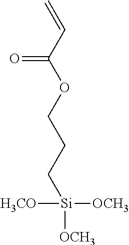 |
| 18 | 90% SIA0200.0 10% SIH5841.5 | 82 | | |
| 19 | Membrane coated as in Example 17, submerged in SBMA | 78 | SBMA | 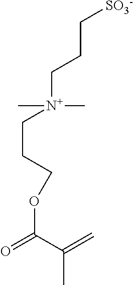 |
| 20 | Membrane coated as in Example 17, submerged in SBMA and FMA | 93 | FMA | 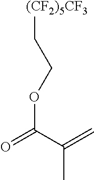 |

### Examples 21-27, Comparative Examples 1-7

### Pretreatment with Coagulant or Flocculant

Testing water (TSS=1000 ppm, TOC=250 ppm and TDS=102,500 ppm) was mixed at 300-500 rpm, then the polyelectrolytes were added and the water continued to be stirred at 300-500 rpm for 1 min, then at 50 rpm for 20 min before being poured into a stirred pressure tank for the filtration test. The tank pressure was kept at 6 psi. The testing membrane was ePTFE/PTFE One-Pass membrane with 1.5 μm pore size, non-coated or coated as in Example 16, which was pre-wetted with isopropanol. During the test, about 500 mL deionized water was first passed though the membrane for flux measurement, and then the chemical-treated produced water was filtered. The flow rate was measured by the increase of filtrate weight over time. After that, the membrane was recovered by gently removing the built-up cake layer from the membrane surface using a deionized water squirt bottle. Finally, 500 mL deionized water was again passed through the recovered membrane. The membrane recovery % was calculated as the ratio of deionized water flux after and before the filtration of the produced water.

Results for Comparative Examples 1-7 are summarized in Table 4, and for Examples 21-27 in Table 5. At all doses tested, there was no significant change in mean flux rate using either non-coated or coated membrane. Surprisingly, in all the tests the coated membrane showed much higher recovery % than the non-coated one. The membrane recovery % was 88% at 0.5 ppm cationic flocculant (acrylamide and AETAC copolymer) dose and 57% at 1 ppm, which were 30-40% higher than those of the non-coated one. The hydrophilic-oleophobic coating improved the membrane recovery from 17% to 96% with 0.1 ppm anionic flocculant (copolymer of acrylamide and acrylic acid), from 27% to 72% with 0.5 ppm non-ionic flocculant (polyacrylamide) and from 1% to 37% with 250 ppm coagulant (tannin-based amine). The above results indicate that the hydrophilic-oleophobic coating extensively reduces attraction between polymer molecules and membrane surface, making the coated membrane more resistant to polyelectrolyte coagulants and flocculants.

TABLE 4
Uncoated Membranes

| | | Recovery percentage % |
|---|---|---|
| Comp. Ex. No. | Description | (gentle wash) |
| 1 | no chemicals | 92 |
| 2 | cationic flocculant | 45 |
| | 0.5 ppm | |
| 3 | 1.0 ppm | 26 |
| 4 | no chemicals | 88 |
| 5 | anionic flocculant | 17 |
| | 0.1 ppm | |
| 6 | Non-ionic focculant | 27% |
| | 0.5 ppm | |
| 7 | no chemicals | 89 |
| 8 | tannin-based amine | 1 |
| | 250 ppm | |

TABLE 5
Coated Membranes

| | | Recovery percentage % |
|---|---|---|
| Example no. | Description | (gentle wash) |
| 21 | no chemicals | 88 |
| 22 | cationic flocculant | 88 |
| | 0.5 ppm | |
| 23 | 1.0 ppm | 57 |
| 24 | no chemicals | 93 |
| 25 | anionic flocculant | 96 |
| | 0.1 ppm | |
| 26 | Non-ionic flocculant | 72% |
| | 0.5 ppm | |
| 27 | no chemicals | 91 |
| 28 | Coagulant | 37 |
| | 250 ppm | |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for treating water containing dissolved solids, suspended solids, organic material, or a combination thereof, the method comprising contacting the water with a coated membrane comprising a coating material disposed on a membrane substrate, the coating material comprising structural units derived from a compound of formula I, a compound of formula II and a compound of formula III; 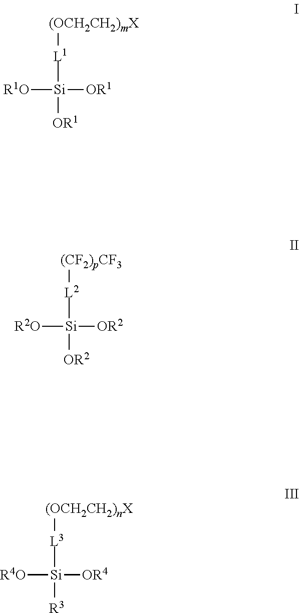
wherein
R¹, R², and R³ are, independently at each occurrence, C₁-C₁₂ alkyl;
R⁴ is alkylsilyl;
L¹ is alkylurethanyl;
L² and L³ are, independently at each occurrence, alkyl;
X is hydroxy, alkoxy, or alkylamino; and
m, n, and p, independently at each occurrence, range between 4 and 9.

2. A method according to claim 1, wherein R¹ and R² are ethyl.

3. A method according to claim 1, wherein L¹ is alkylurethanyl.

4. A method according to claim 1, wherein L² and L³ are C₂-C₃ alkyl.

5. A method according to claim 1, wherein R⁴ is Si(R⁵)₃ and R⁵ is C₁-C₄ alkyl.

6. A method according to claim 1, wherein
R¹ and R² are ethyl; and
L² and L³ are C₂-C₃ alkyl.

7. A method according to claim 1, wherein the compound of formula I is

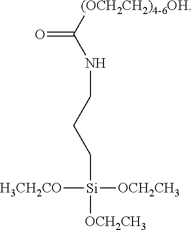

8. A method according to claim 1, wherein the compound of formula II is

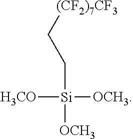

9. A method according to claim 1, wherein the compound of formula III is

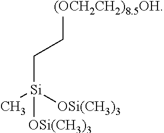

10. A method according to claim 1, wherein about 50-80% of the structural units are derived from a compound of formula I.

11. A method according to claim 1, wherein about 10-30% of the structural units are derived from a compound of formula II.

12. A method according to claim 1, wherein about 5-15% of the structural units are derived from a compound of formula III.

13. A method according to claim 1, wherein the membrane substrate is e-PTFE.

14. A method according to claim 1, additionally comprising combining the water with a water dispersable polymer before contacting the coated membrane with the water.

15. A method according to claim 14, wherein the water dispersable polymer is selected from coagulants, anionic flocculants, cationic flocculants, nonionic flocculants, and combinations thereof.

16. A membrane filtration apparatus comprising a coated membrane joined to a backing, the coated membrane comprising a coating material disposed on a membrane substrate, the coating material comprising structural units derived from a compound of formula I, a compound of formula II and a compound of formula III; 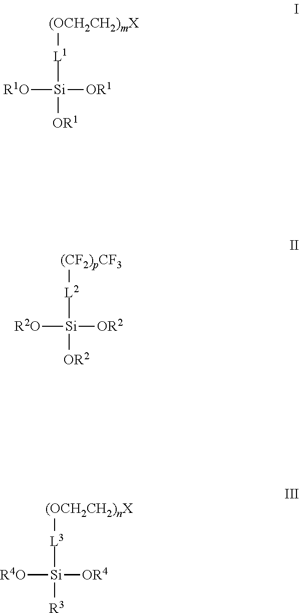
wherein
R¹, R², and R³ are, independently at each occurrence, C₁-C₁₂ alkyl;
R⁴ is alkylsilyl;
L¹ is alkylurethanyl;
L² and L³ are, independently at each occurrence, alkyl;
X is hydroxy, alkoxy, or alkylamino; and
m, n, and p, independently at each occurrence, range between 4 and 9.

17. A membrane filtration apparatus according to claim 16, wherein

[symbol]

18. A membrane filtration apparatus according to claim 16, wherein R¹ and R² are ethyl.

19. A membrane filtration apparatus according to claim 16, wherein L¹ is alkylurethanyl.

20. A membrane filtration apparatus according to claim 16, wherein L² and L³ are C₂-C₃ alkyl.

21. A membrane filtration apparatus according to claim 16, wherein R⁴ is Si(R⁵)₃ and R⁵ is C₁-C₄ alkyl.

22. A membrane filtration apparatus according to claim 16, wherein
R¹ and R² are ethyl; and
L² and L³ are C₂-C₃ alkyl.

23. A membrane filtration apparatus according to claim 16, wherein the compound of formula I is 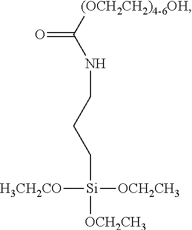
the compound of formula II is 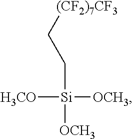
and
the compound of formula III is

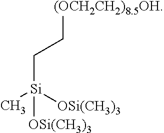

24. A membrane filtration apparatus according to claim 16, wherein about 50-80% of the structural units are derived from a compound of formula I, about 10-30% of the structural units are derived from a compound of formula II, and about 5-15% of the structural units are derived from a compound of formula III.

25. A membrane filtration apparatus according to claim 16, wherein the membrane substrate is e-PTFE.

26. A method for treating water containing dissolved solids, suspended solids, organic material, or a combination thereof, the method comprising contacting the water with a coated membrane comprising a coating material disposed on a membrane substrate, the coating material comprising structural units derived from a compound of formula IV, a compound of formula V and a compound of formula VI 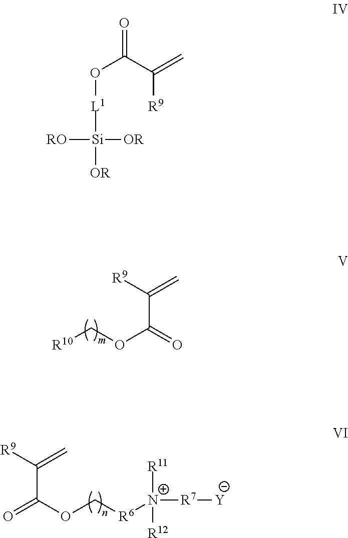
wherein
R⁹ is independently at each occurrence a hydrogen, or a linear or branched C₁-C₄ alkyl group;
R¹⁰ is a linear or branched C₁-C₃₀ fluoroalkyl group;
R¹¹ and R¹² are independently at each occurrence a linear or branched C₁-C₁₂ alkyl group; a C₅-C₁₂ carbocyclic group, or a C₅-C₁₂ heterocyclic group, and R⁶ and R⁷ are independently at each occurrence a linear or branched C₁-C₁₂ alkylene group, a linear or branched C₂-C₁₂ alkenylene group, a linear or branched C₂-C₁₂ alkylnlene group, a C₅-C₁₂ carbocyclic group, or a C₅-C₁₂ heterocyclic group, or at least two of R¹¹, R¹², R⁶, and R⁷ together with the nitrogen atom to which they are attached form a heterocyclic ring containing 5 to 7 atoms;
Y is an anionic group; and
m and n are independently at each occurrence an integer ranging from 1 to 5.
